(19) United States
(12) Patent Application Publication
(10) Pub. No.: US 2022/0225483 A1
(43) Pub. Date: Jul. 14, 2022

(54) SYSTEMS AND METHODS WITH TRIAC DIMMERS FOR VOLTAGE CONVERSION RELATED TO LIGHT EMITTING DIODES

(71) Applicant: ON-BRIGHT ELECTRONICS (SHANGHAI) CO., LTD., Shanghai (CN)

(72) Inventors: JIQING YANG, Shanghai (CN); ZHUOYAN LI, Shanghai (CN); LIQIANG ZHU, Shanghai (CN); JUN ZHOU, Shanghai (CN)

(21) Appl. No.: 17/528,153

(22) Filed: Nov. 16, 2021

Related U.S. Application Data
(63) Continuation of application No. 16/791,329, filed on Feb. 14, 2020, now Pat. No. 11,224,105.

(30) Foreign Application Priority Data
Feb. 19, 2019 (CN) 201910124049.0

(51) Int. Cl. H05B 45/37

(52) U.S. Cl. CPC H05B 45/37

(57) ABSTRACT

System and method for voltage conversion to drive one or more light emitting diodes with at least a TRIAC dimmer. For example, the system includes: a phase detector configured to receive a first rectified voltage generated based at least in part on an AC input voltage processed by at least the TRIAC dimmer, the phase detector being further configured to generate a digital signal representing phase information associated with the first rectified voltage; a voltage generator configured to receive the digital signal and generate a DC voltage based at least in part on the digital signal; and a driver configured to receive the DC voltage and affect, based at least in part on the DC voltage, a current flowing through the one or more light emitting diodes; wherein the current changes with the phase information according to a predetermined function.

### 1. CROSS-REFERENCES TO RELATED APPLICATIONS

This application claims priority to Chinese Patent Application No. 201910124049.0, filed Feb. 19, 2019, incorporated by reference herein for all purposes.

### 2. BACKGROUND OF THE INVENTION

Certain embodiments of the present invention are directed to integrated circuits. More particularly, some embodiments of the invention provide systems and methods for voltage conversion. Merely by way of example, some embodiments of the invention have been applied to light emitting diode (LED) lighting systems that include TRIAC dimmers. But it would be recognized that the invention has a much broader range of applicability.

A conventional lighting system often includes a TRIAC dimmer that is a dimmer including a Triode for Alternating Current (TRIAC). For example, the TRIAC dimmer is either a leading-edge TRIAC dimmer or a trailing-edge TRIAC dimmer. Usually, the leading-edge TRIAC dimmer and the trailing-edge TRIAC dimmer are configured to receive an alternating-current (AC) input voltage, process the AC input voltage by clipping part of the waveform of the AC input voltage, and generate a voltage that is then received by a rectifier (e.g., a full wave rectifying bridge) in order to generate a rectified output voltage. The rectified output voltage is converted to a DC voltage by an RC filtering circuit that includes a resistor and a capacitor, and the DC voltage is then used to control a driver to generate a drive signal for one or more light emitting diodes (LEDs).

FIG. 1 is a simplified diagram of a conventional lighting system that includes a TRIAC dimmer. The conventional lighting system 100 includes a TRIAC dimmer 110, a rectifier 120, resistors 170, 172 and 174, a capacitor 180, a driver 140, and one or more LEDs 150. As shown, the resistors 170 and 172 are parts of a voltage divider, and the resistor 174 and the capacitor 180 are parts of an RC filtering circuit. For example, the rectifier 120 is a full wave rectifying bridge that includes diodes 132, 134, 136 and 138.

The TRIAC dimmer 110 receives an AC input voltage 114 (e.g., VLine) and generates a voltage 112. The voltage 112 is received by the rectifier 120 (e.g., a full wave rectifying bridge), which then generates a rectified output voltage 122. The rectified output voltage 122 is larger than or equal to zero. As shown in FIG. 1, the rectified output voltage 122 is received by the resistor 170 and the one or more LEDs 150. In response, the voltage divider including the resistors 170 and 172 generates a voltage 182 (e.g., Vₛ), as follows:

$${V}_{s} = \frac{{R}_{2}}{{R}_{1} + {R}_{2}} \times {V}_{o} \qquad ( Equation 1 )$$

where Vₛ represents the voltage 182, and Vₒ represents the voltage 122. Additionally, R₁ represents the resistance of the resistor 170, and R₂ represents the resistance of the resistor 172. The voltage 182 (e.g., Vₛ) is received by the resistor 174. In response, the RC filtering circuit including the resistor 174 and the capacitor 180 generates a reference voltage 184 (e.g., VREF). For example, the reference voltage 184 (e.g., V_{REF}) is a DC voltage. The reference voltage 184 is received by the driver 140, which in response affects (e.g., controls) a load current 142 that flows through the one or more LEDs 150. Referring to FIG. 1, each cycle of the AC input voltage 114 (e.g., V_{Line}) has a phase angel (e.g., ϕ) that changes from 0 to π and then from π to 2π.

FIG. 2A shows a conventional timing diagram for the voltage 182 of the lighting system 100 that includes a leading-edge TRIAC dimmer as the TRIAC dimmer 110, and FIG. 2B shows a conventional timing diagram for the voltage 182 of the lighting system 100 that includes a trailing-edge TRIAC dimmer as the TRIAC dimmer 110. For each cycle of the AC input voltage 114 (e.g., V_{Line}), time t₁ corresponds to phase 0, time t₂ corresponds to phase ϕ_{J}, time t₃ corresponds to phase ϕ_{K}, time t₄ corresponds to phase π, time is corresponds to phase π+ϕ_{J}, time t₆ corresponds to phase π+ϕ_{K}, and time t₇ corresponds to phase 2π.

As shown in FIG. 2A, the waveform 220 represents the voltage 182 (e.g., Vₛ) as a function of time if the TRIAC dimmer 110 is a leading-edge TRIAC dimmer. The leading-edge TRIAC dimmer processes the AC input voltage 114 (e.g., V_{Line}) by clipping part of the waveform that corresponds to the phase starting at 0 and ending at ϕ_{J} and clipping part of the waveform that corresponds to the phase starting at π and ending at π+ϕ_{J}, for each cycle of the AC input voltage 114 (e.g., V_{Line}). For each cycle, the AC input voltage 114 (e.g., V_{Line}) is clipped by the leading-edge TRIAC dimmer from time t₁ to time t₂ and from time t₄ to time t₅, but the AC input voltage 114 (e.g., V_{Line}) is not clipped by the leading-edge TRIAC dimmer from time t₂ to time t₄ and from time t₅ to time t₇.

As shown in FIG. 2B, the waveform 230 represents the voltage 182 (e.g., Vₛ) as a function of time if the TRIAC dimmer 110 is a trailing-edge TRIAC dimmer. The trailing-edge TRIAC dimmer processes the AC input voltage 114 (e.g., V_{Line}) by clipping part of the waveform that corresponds to the phase starting at ϕ_{K} and ending at π and clipping part of the waveform that corresponds to the phase starting at ϕ+ϕ_{K} and ending at 2π, for each cycle of the AC input voltage 114 (e.g., V_{Line}). For each cycle, the AC input voltage 114 (e.g., V_{Line}) is clipped by the trailing-edge TRIAC dimmer from time t₃ to time t₄ and from time t₆ to time t₇, but the AC input voltage 114 (e.g., V_{Line}) is not clipped by the leading-edge TRIAC dimmer from time t₁ to time t₃ and from time t₄ to time t₆.

As shown in FIG. 1, it is often difficult to integrate the RC filtering circuit into an integrated circuit (IC) chip with limited size. Hence it is highly desirable to improve the LED drive techniques that use one or more TRIAC dimmers.

### 3. BRIEF SUMMARY OF THE INVENTION

Certain embodiments of the present invention are directed to integrated circuits. More particularly, some embodiments of the invention provide systems and methods for voltage conversion. Merely by way of example, some embodiments of the invention have been applied to light emitting diode (LED) lighting systems that include TRIAC dimmers. But it would be recognized that the invention has a much broader range of applicability.

According to some embodiments, a system for voltage conversion to drive one or more light emitting diodes with at least a TRIAC dimmer, the system comprising: a phase detector configured to receive a first rectified voltage generated based at least in part on an AC input voltage processed by at least the TRIAC dimmer, the phase detector being further configured to generate a digital signal representing phase information associated with the first rectified voltage; a voltage generator configured to receive the digital signal and generate a DC voltage based at least in part on the digital signal; and a driver configured to receive the DC voltage and affect, based at least in part on the DC voltage, a current flowing through the one or more light emitting diodes; wherein the current changes with the phase information according to a predetermined function.

According to certain embodiments, a method for voltage conversion to drive one or more light emitting diodes with at least a TRIAC dimmer, the method comprising: receiving a first rectified voltage generated based at least in part on an AC input voltage processed by at least the TRIAC dimmer; processing at least information associated with the first rectified voltage; generating a digital signal representing phase information associated with the first rectified voltage; receiving the digital signal; generating a DC voltage based at least in part on the digital signal; receiving the DC voltage; and affecting, based at least in part on the DC voltage, a current flowing through the one or more light emitting diodes; wherein the current changes with the phase information according to a predetermined function.

Depending upon embodiment, one or more benefits may be achieved. These benefits and various additional objects, features and advantages of the present invention can be fully appreciated with reference to the detailed description and accompanying drawings that follow.

### 4. BRIEF DESCRIPTION OF THE DRAWINGS

FIG. 1 is a simplified diagram of a conventional lighting system that includes a TRIAC dimmer.

FIG. 2A shows a conventional timing diagram for a voltage of the lighting system as shown in FIG. 1 that includes a leading-edge TRIAC dimmer as the TRIAC dimmer.

FIG. 2B shows a conventional timing diagram for a voltage of the lighting system as shown in FIG. 1 that includes a trailing-edge TRIAC dimmer as the TRIAC dimmer.

FIG. 3 is a simplified diagram of a lighting system that includes a TRIAC dimmer according to some embodiments of the present invention.

FIG. 4A shows a timing diagram for a voltage of the lighting system as shown in FIG. 3 that includes a leading-edge TRIAC dimmer as the TRIAC dimmer according to some embodiments of the present invention.

FIG. 4B shows a timing diagram for a voltage of the lighting system as shown in FIG. 3 that includes a trailing-edge TRIAC dimmer as the TRIAC dimmer according to certain embodiments of the present invention.

FIG. 5 is a simplified diagram showing a relative magnitude of the load current as a function of the phase change for the lighting system as shown in FIG. 3 according to some embodiments of the present invention.

FIG. 6 is a simplified diagram of the voltage generator of the lighting system as shown in FIG. 3 according to some embodiments of the present invention.

FIG. 7 is a simplified diagram of the voltage generator of the lighting system as shown in FIG. 3 according to certain embodiments of the present invention.

FIG. 8 is a simplified diagram of a method for generating the reference voltage by the lighting system as shown in FIG. 3 according to some embodiments of the present invention.

### 5. DETAILED DESCRIPTION OF THE INVENTION

Certain embodiments of the present invention are directed to integrated circuits. More particularly, some embodiments of the invention provide systems and methods for voltage conversion. Merely by way of example, some embodiments of the invention have been applied to light emitting diode (LED) lighting systems that include TRIAC dimmers. But it would be recognized that the invention has a much broader range of applicability.

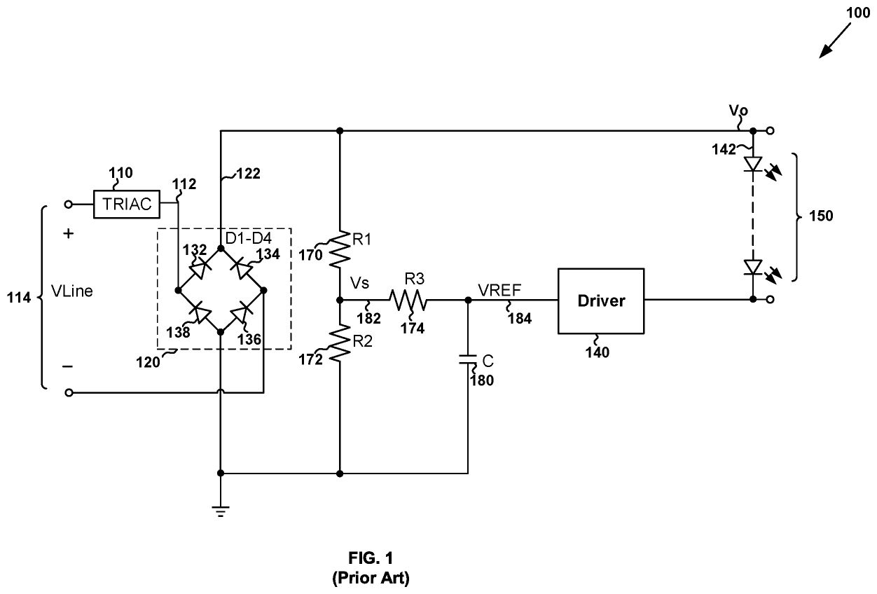

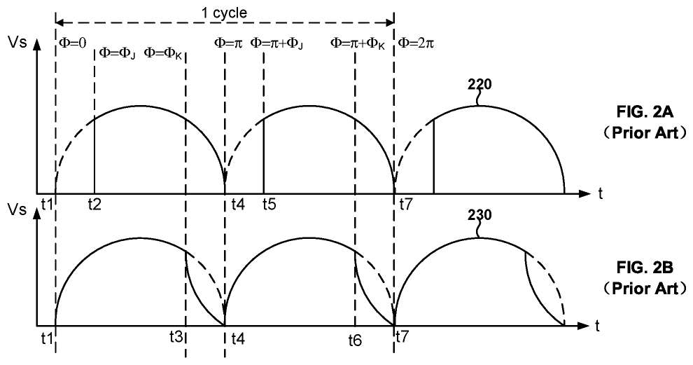

Referring to FIG. 1, the conventional lighting system 100 uses the RC filtering circuit that includes the resistor 174 and the capacitor 180. In order to make the reference voltage 184 (e.g., V_{REF}) less dependent on time (e.g., to make the reference voltage 184 be a DC voltage), the RC time constant of the RC filtering circuit often needs to be large. For example, the RC time constant is determined as follows:

τ=R₃×C (Equation 2)

where R₃ represents the resistance of the resistor 174, and C represents the capacitance of the capacitor 180. As an example, if the capacitor 180 is a parallel plate capacitor, its capacitance is determined as follows:

$$C = ɛ \times \frac{A}{d} \qquad ( Equation 3 )$$

where C represents the capacitance of the capacitor 180. Additionally, A represents the area of the smaller of the two conductive plates, and d represents the distance between the two conductive plates of the capacitor 180.

As shown in Equations 2 and 3, to increase the RC time constant, the area of the smaller of the two conductive plates may need to become larger. If the area of the smaller of the two conductive plates becomes larger, integrating the capacitor 180 into the IC chip becomes more difficult. Even though the techniques of equivalent capacitance can be used to help integrating the RC filtering circuit into the IC chip, the capacitor 180 often still occupies a significant area of the IC chip.

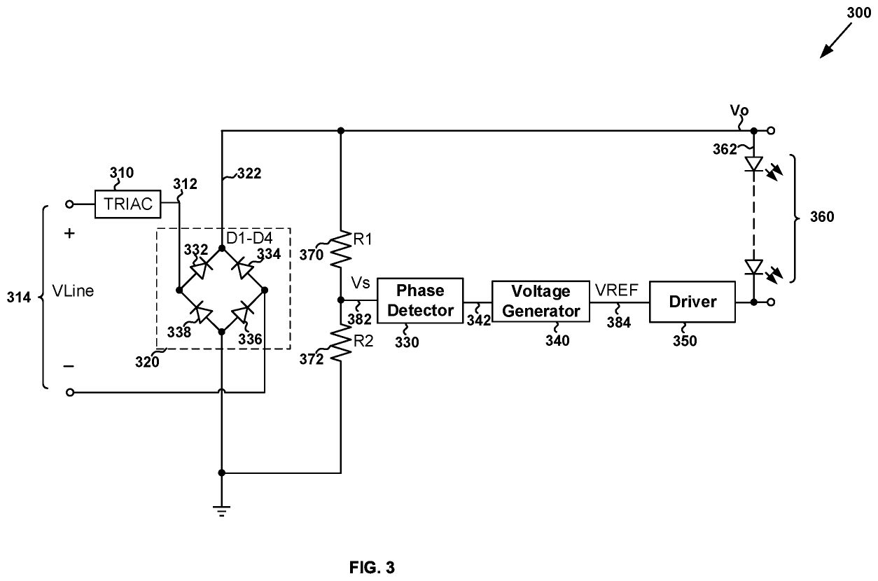

FIG. 3 is a simplified diagram of a lighting system that includes a TRIAC dimmer according to some embodiments of the present invention. This diagram is merely an example, which should not unduly limit the scope of the claims. One of ordinary skill in the art would recognize many variations, alternatives, and modifications. The lighting system 300 includes a TRIAC dimmer 310, a rectifier 320, resistors 370 and 372, a phase detector 330, a voltage generator 340, a driver 350, and one or more LEDs 360. For example, the resistors 370 and 372 are parts of a voltage divider. As an example, the rectifier 320 is a full wave rectifying bridge that includes diodes 332, 334, 336 and 338. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced. Further details of these components are found throughout the present specification.

In certain embodiments, the TRIAC dimmer 310 receives an AC input voltage 314 (e.g., V_{Line}) and generates a voltage 312. For example, the voltage 312 is received by the rectifier 320 (e.g., a full wave rectifying bridge), which then generates a rectified output voltage 322. As an example, the rectified output voltage 322 is larger than or equal to zero. In some embodiments, as shown in FIG. 3, the rectified output voltage 322 is received by the resistor 370 and the one or more LEDs 360. For example, in response, the voltage divider including the resistors 370 and 372 generates a voltage 382 (e.g., Vₛ), as follows:

$${V}_{s} = \frac{{R}_{2}}{{R}_{1} + {R}_{2}} \times {V}_{o} \qquad ( Equation 4 )$$

where Vₛ represents the voltage 382, and Vₒ represents the voltage 322. Additionally, R₁ represents the resistance of the resistor 370, and R₂ represents the resistance of the resistor 372. As an example, the voltage 382 (e.g., Vₛ) is a rectified voltage.

According to certain embodiments, the voltage 382 (e.g., Vₛ) is received by the phase detector 330. For example, the phase detector 330 and the voltage generator 340 convert the voltage 382 (e.g., Vₛ) to a reference voltage 384 (e.g., V_{REF}). As an example, the reference voltage 384 (e.g., V_{REF}) is a DC voltage. According to some embodiments, the reference voltage 384 is received by the driver 350, which in response affects (e.g., controls) a load current 362 that flows through the one or more LEDs 360. Referring to FIG. 3, as an example, each cycle of the AC input voltage 314 (e.g., V_{Line}) has a phase angel (e.g., ϕ) that changes from 0 to π and then from π to 2π.

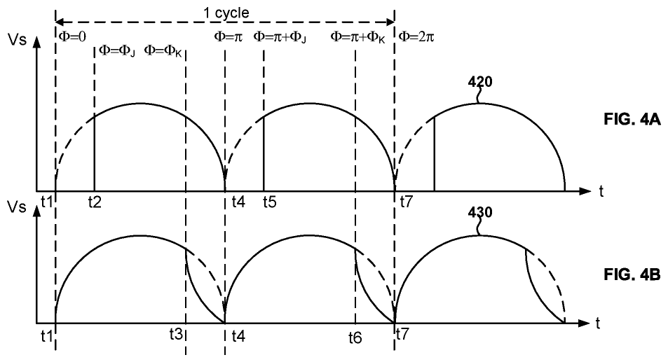

FIG. 4A shows a timing diagram for the voltage 382 of the lighting system 300 that includes a leading-edge TRIAC dimmer as the TRIAC dimmer 310 according to some embodiments of the present invention, and FIG. 4B shows a timing diagram for the voltage 382 of the lighting system 300 that includes a trailing-edge TRIAC dimmer as the TRIAC dimmer 310 according to certain embodiments of the present invention.

These diagrams are merely examples, which should not unduly limit the scope of the claims. One of ordinary skill in the art would recognize many variations, alternatives, and modifications. As an example, for each cycle of the AC input voltage 114 (e.g., V_{Line}), time t₁ corresponds to phase 0, time t₂ corresponds to phase ϕ_{J}, time t₃ corresponds to phase ϕ_{K}, time t₄ corresponds to phase π, time t₅ corresponds to phase π+ϕ_{J}, time t₆ corresponds to phase π+ϕ_{K}, and time t₇ corresponds to phase 2π.

As shown in FIG. 4A, the waveform 420 represents the voltage 382 (e.g., Vₛ) as a function of time if the TRIAC dimmer 310 is a leading-edge TRIAC dimmer. For example, the leading-edge TRIAC dimmer processes the AC input voltage 314 (e.g., V_{Line}) by clipping part of the waveform that corresponds to the phase starting at 0 and ending at ϕ_{J} and clipping part of the waveform that corresponds to the phase starting at π and ending at π+ϕ_{J}, for each cycle of the AC input voltage 314 (e.g., V_{Line}). As an example, for each cycle, the AC input voltage 314 (e.g., V_{Line}) is clipped by the leading-edge TRIAC dimmer from time t₁ to time t₂ and from time t₄ to time t₅, but the AC input voltage 314 (e.g., V_{Line}) is not clipped by the leading-edge TRIAC dimmer from time t₂ to time t₄ and from time t₅ to time t₇.

As shown in FIG. 4B, the waveform 430 represents the voltage 382 (e.g., Vₛ) as a function of time if the TRIAC dimmer 310 is a trailing-edge TRIAC dimmer. For example, the trailing-edge TRIAC dimmer processes the AC input voltage 314 (e.g., V_{Line}) by clipping part of the waveform that corresponds to the phase starting at ϕ_{K} and ending at π and clipping part of the waveform that corresponds to the phase starting at π+ϕ_{K} and ending at 2π, for each cycle of the AC input voltage 314 (e.g., V_{Line}). As an example, for each cycle, the AC input voltage 314 (e.g., V_{Line}) is clipped by the trailing-edge TRIAC dimmer from time t₃ to time t₄ and from time t₆ to time t₇, but the AC input voltage 314 (e.g., V_{Line}) is not clipped by the leading-edge TRIAC dimmer from time t₁ to time t₃ and from time t₄ to time t₆.

Referring to FIG. 3, the phase detector 330 receives the voltage 382 (e.g., Vₛ) and generates a signal 342 (e.g., a digital signal) that represents phase information of the voltage 382 (e.g., Vₛ) according to some embodiments. In certain examples, the signal 342 (e.g., a digital signal) represents the phase change, within which, for each half cycle, the AC input voltage 314 (e.g., V_{Line}) is not clipped by the TRIAC dimmer 310. In some examples, one half cycle of the AC input voltage 314 corresponds to one cycle of the voltage 382. For example, as shown in FIG. 4A, the signal 342 (e.g., a digital signal) represents the phase change that is equal to π−ϕ_{J}, which is calculated from either π−_{J} or from 2π−(π+ϕ_{J}). As an example, as shown in FIG. 4B, the signal 342 (e.g., a digital signal) represents the phase change that is equal to ϕ_{K}, which is calculated from either ϕ_{K-0} or from (π+ϕ_{K})−π.

In some examples, the phase detector 330 determines the time duration, during which, for each half cycle, the AC input voltage 314 (e.g., V_{Line}) is not clipped by the TRIAC dimmer 310, and then uses this time duration to determine the phase change, within which, for each half cycle, the AC input voltage 314 (e.g., V_{Line}) is not clipped by the TRIAC dimmer 310. As an example, the phase change is determined as follows:

$$A = \frac{{T}_{C}}{{T}_{A}} \times π \qquad ( Equation 5 )$$

where A represents the phase change, within which, for each half cycle, the AC input voltage 314 (e.g., V_{Line}) is not clipped by the TRIAC dimmer 310. Additionally, T_{C} represents the time duration, during which, for each half cycle, the AC input voltage 314 (e.g., V_{Line}) is not clipped by the TRIAC dimmer 310. Moreover, T_{A} represents the time duration of one half cycle of the AC input voltage 314 (e.g., V_{Line}). For example, one half cycle of the AC input voltage 314 (e.g., V_{Line}) is the same as one cycle of the voltage 382 (e.g., Vₛ) in duration.

According to certain embodiments, the phase detector 330 includes a counter. In some examples, the counter keeps counting when the AC input voltage 314 (e.g., V_{Line}) is not clipped by the TRIAC dimmer 310, but the counter does not count when the AC input voltage 314 (e.g., V_{Line}) is clipped by the TRIAC dimmer 310. In some examples, as shown in FIG. 4A, the counter starts counting from zero at time t₂ and stops counting at time t₄, resets to zero, and then starts counting again at time t₅ and stops counting at time t₇. For example, the total number of counts is the number of counts made by the counter either from time t₂ to time t₄ or from time t₅ to time t₇. In certain examples, as shown in FIG. 4B, the counter starts counting from zero at time t₁ and stops counting at time t₃, resets to zero, and then starts counting again at time t₄ and stops counting at time t₆. For example, the total number of counts is the number of counts made by the counter either from time t₁ to time t₃ or from time t₄ to time t₆.

In some embodiments, for each half cycle of the AC input voltage 314 (e.g., each cycle of the voltage 382), the total number of counts by the counter is used by the phase detector 330 to determine the time duration, during which, for each half cycle, the AC input voltage 314 (e.g., V_{Line}) is not clipped by the TRIAC dimmer 310. For example, as shown in FIG. 4A, the time duration is either equal to t₄−t₂ or equal to t₇−t₅, and the time duration is determined by multiplying the total number of counts by the time interval between two consecutive counts. As an example, as shown in FIG. 4B, the time duration is either equal to t₃−t₁ or equal to t₆−t₄, and the time duration is determined by multiplying the total number of counts by the time interval between two consecutive counts.

In certain embodiments, the phase detector 330 uses the total number of counts to determine the phase change, within which, for each half cycle, the AC input voltage 314 (e.g., V_{Line}) is not clipped by the TRIAC dimmer 310. As an example, the phase change is determined as follows:

$$A = \frac{{C}_{C} \times {T}_{I}}{{T}_{A}} \times π \qquad ( Equation 6 )$$

where A represents the phase change, within which, for each half cycle, the AC input voltage 314 (e.g., V_{Line}) is not clipped by the TRIAC dimmer 310. Additionally, C_{C} represents the total number of counts when, for each half cycle, the AC input voltage 314 (e.g., V_{Line}) is not clipped by the TRIAC dimmer 310. Moreover, T₁ represents the time interval between two consecutive counts. Also, T_{A} represents the time duration of one half cycle of the AC input voltage 314 (e.g., V_{Line}). For example, one half cycle of the AC input voltage 314 (e.g., V_{Line}) is the same as one cycle of the voltage 382 (e.g., Vₛ) in duration.

Referring to FIG. 3, the voltage generator 340 receives the signal 342 (e.g., a digital signal) that represents the phase change, within which, for each half cycle, the AC input voltage 314 (e.g., V_{Line}) is not clipped by the TRIAC dimmer 310, and generates the reference voltage 384 (e.g., V_{REF}) according to some embodiments. For example, the reference voltage 384 (e.g., V_{REF}) is a DC voltage. As an example, the reference voltage 384 is received by the driver 350, which in response affects (e.g., controls) the load current 362 that flows through the one or more LEDs 360.

According to certain embodiments, the voltage generator 340 and the driver 350 use the signal 342 (e.g., a digital signal) to affect (e.g., to control) the load current 362. For example, the signal 342 (e.g., a digital signal) represents the phase change, within which, for each half cycle, the AC input voltage 314 (e.g., V_{Line}) is not clipped by the TRIAC dimmer 310. As an example, the load current 362 flows through the one or more LEDs 360.

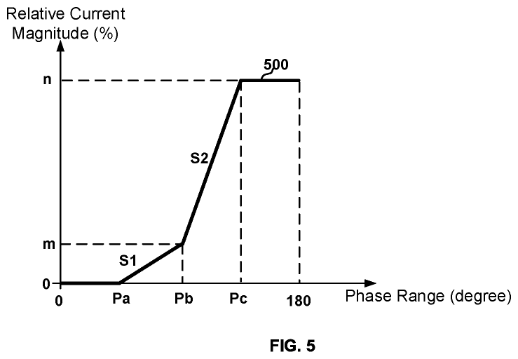

FIG. 5 is a simplified diagram showing a relative magnitude of the load current 362 as a function of the phase change for the lighting system 300 according to some embodiments of the present invention. This diagram is merely an example, which should not unduly limit the scope of the claims. One of ordinary skill in the art would recognize many variations, alternatives, and modifications. For example, the curve 500 represents the relative magnitude of the load current 362 as a function of the phase change.

As shown in FIG. 5, the horizontal axis represents the phase change, within which, for each half cycle, the AC input voltage 314 (e.g., V_{Line}) is not clipped by the TRIAC dimmer 310 according to certain embodiments. In some examples, the phase change is represented in degrees. In certain examples, 0 degree corresponds to 0 for the phase change, and 180 degrees correspond to π for the phase change. For example, 0 degree for the phase change indicates that an entire half cycle of the AC input voltage 314 (e.g., V_{Line}) is clipped by the TRIAC dimmer 310. As an example, 180 degrees for the phase change indicates none of a half cycle of the AC input voltage 314 (e.g., V_{Line}) is clipped by the TRIAC dimmer 310.

According to some embodiments, the vertical axis represents the relative magnitude of the load current 362 that flows through the one or more LEDs 360. In some examples, the relative magnitude is represented in percentage. For example, 0 percent (i.e., 0%) for the relative magnitude of the load current 362 indicates that the one or more LEDs 360 are completely turned off (e.g., to complete darkness). As an example, 100 percent (i.e., 100%) for the relative magnitude of the load current 362 indicates that the one or more LEDs 360 are completely turned on (e.g., to the maximum brightness).

In some embodiments, as shown by the curve 500, if the phase change is equal to or larger than 0 degree but smaller than Pa degrees, the relative magnitude of the load current 362 is equal to zero percent. In certain examples, if the phase change is larger than Pₐ degrees but smaller than P_{b} degrees, the relative magnitude of the load current 362 increases with the phase change linearly at a slope Si from zero percent to m percent. For example, if the phase change is equal to Pₐ degrees, the relative magnitude of the load current 362 is equal to zero percent. As an example, if the phase change is equal to P_{b} degrees, the relative magnitude of the load current 362 is equal to m percent. In some examples, if the phase change is larger than P_{b} degrees but smaller than P_{c} degrees, the relative magnitude of the load current 362 increases with the phase change linearly at a slope S₂ from m percent to n percent. For example, if the phase change is equal to P_{b} degrees, the relative magnitude of the load current 362 is equal to m percent. As an example, if the phase change is equal to P_{c} degrees, the relative magnitude of the load current 362 is equal to n percent. In certain examples, if the phase change is larger than P_{c} degrees but smaller than or equal to 180 degrees, the relative magnitude of the load current 362 is equal to n percent. In certain embodiments, 0≤Pₐ≤P_{b}≤P_{c}≤180, and 0≤m≤n≤100. As an example, 0<Pₐ<P_{b}<P_{c}<180, and 0<m<n≤100. For example, Pₐ=40, P_{b}=80, P_{c}=120, 0<m<n, and n=100. In some examples, S₁ and S₂ are equal to each other. In certain examples, S₁ and S₂ are not equal to each other.

According to some embodiments, the curve 500 is used by the voltage generator 340 and the driver 350 to affect (e.g., to control), in response to the signal 342, the load current 362 that flows through the one or more LEDs 360. For example, the curve 500 is designed by taking into account the compatibility of the TRIAC dimmer 310 and/or the reaction of human eyes to brightness changes of the one or more LEDs 360.

As discussed above and further emphasized here, FIG. 3 is merely an example, which should not unduly limit the scope of the claims. One of ordinary skill in the art would recognize many variations, alternatives, and modifications. In certain embodiments, the phase detector 330 receives the voltage 382 (e.g., Vₛ) and generates the signal 342 (e.g., a digital signal) that represents the total number of counts made within each half cycle of the AC input voltage 314 (e.g., each cycle of the voltage 382) when the AC input voltage 314 (e.g., V_{Line}) is not clipped by the TRIAC dimmer 310. As an example, the total number of counts is a binary number. For example, the voltage generator 340 receives the signal 342 (e.g., a digital signal) that represents the total number of counts, and determines, according to Equation 6, the phase change, within which, for each half cycle, the AC input voltage 314 (e.g., V_{Line}) is not clipped by the TRIAC dimmer 310. As an example, the voltage generator 340 uses the phase change to generate the reference voltage 384 (e.g., V_{REF}). In some examples, the voltage generator 340 and the driver 350 use the curve 500 to affect (e.g., to control), in response to the signal 342, the load current 362 that flows through the one or more LEDs 360.

In some embodiments, the phase detector 330 receives the voltage 382 (e.g., Vₛ) and generates the signal 342 (e.g., a digital signal) that represents the time duration, during which, for each half cycle, the AC input voltage 314 (e.g., V_{Line}) is not clipped by the TRIAC dimmer 310. For example, the voltage generator 340 receives the signal 342 (e.g., a digital signal) that represents the time duration, and determines, according to Equation 5, the phase change, within which, for each half cycle, the AC input voltage 314 (e.g., V_{Line}) is not clipped by the TRIAC dimmer 310. As an example, the voltage generator 340 uses the phase change to generate the reference voltage 384 (e.g., V_{REF}). In some examples, the voltage generator 340 and the driver 350 use the curve 500 to affect (e.g., to control), in response to the signal 342, the load current 362 that flows through the one or more LEDs 360.

Also, as discussed above and further emphasized here, FIG. 3, FIG. 4A, FIG. 4B and FIG. 5 are merely examples, which should not unduly limit the scope of the claims. One of ordinary skill in the art would recognize many variations, alternatives, and modifications. In certain embodiments, the phase detector 330 receives the voltage 382 (e.g., Vₛ) and generates the signal 342 (e.g., a digital signal) that represents the phase change, within which, for each half cycle, the AC input voltage 314 (e.g., V_{Line}) is clipped by the TRIAC dimmer 310. For example, the curve 500 is also modified so that the voltage generator 340 and the driver 350 use the curve 500 to affect (e.g., to control), in response to the signal 342, the load current 362 that flows through the one or more LEDs 360. In some embodiments, the phase detector 330 receives the voltage 382 (e.g., Vₛ) and generates the signal 342 (e.g., a digital signal) that represents the total number of counts made within each half cycle of the AC input voltage 314 (e.g., each cycle of the voltage 382) when the AC input voltage 314 (e.g., V_{Line}) is clipped by the TRIAC dimmer 310. For example, the curve 500 is also modified so that the voltage generator 340 and the driver 350 use the curve 500 to affect (e.g., to control), in response to the signal 342, the load current 362 that flows through the one or more LEDs 360. In certain embodiments, the phase detector 330 receives the voltage 382 (e.g., Vₛ) and generates the signal 342 (e.g., a digital signal) that represents the time duration, during which, for each half cycle, the AC input voltage 314 (e.g., V_{Line}) is clipped by the TRIAC dimmer 310. For example, the curve 500 is also modified so that the voltage generator 340 and the driver 350 use the curve 500 to affect (e.g., to control), in response to the signal 342, the load current 362 that flows through the one or more LEDs 360.

According to some embodiments, with the modified curve 500, if the phase change is equal to or larger than 0 degree but smaller than Pₐ degrees, the relative magnitude of the load current 362 is equal to n percent. In certain examples, if the phase change is larger than Pₐ degrees but smaller than P_{b} degrees, the relative magnitude of the load current 362 decreases with the phase change linearly at a slope S₁ from n percent to m percent. For example, if the phase change is equal to Pₐ degrees, the relative magnitude of the load current 362 is equal to n percent. As an example, if the phase change is equal to P_{b} degrees, the relative magnitude of the load current 362 is equal to m percent. In some examples, if the phase change is larger than P_{b} degrees but smaller than P_{c} degrees, the relative magnitude of the load current 362 decreases with the phase change linearly at a slope S₂ from m percent to 0 percent. For example, if the phase change is equal to P_{b} degrees, the relative magnitude of the load current 362 is equal to m percent. As an example, if the phase change is equal to P_{c} degrees, the relative magnitude of the load current 362 is equal to 0 percent. In certain examples, if the phase change is larger than P_{c} degrees but smaller than or equal to 180 degrees, the relative magnitude of the load current 362 is equal to 0 percent. In certain embodiments, 0≤Pₐ≤P_{b}≤P_{c}≤180, and 0≤m≤n≤100. As an example, 0<Pₐ<P_{b}<P_{c}<180, and 0<m<n≤100. For example, Pₐ=40, P_{b}=80, P_{c}=120, 0<m<n, and n=100. In some examples, S₁ and S₂ are equal to each other. In certain examples, S₁ and S₂ are not equal to each other.

Moreover, as discussed above and further emphasized here, FIG. 5 is merely an example, which should not unduly limit the scope of the claims. One of ordinary skill in the art would recognize many variations, alternatives, and modifications. In certain embodiments, the curve 500 represents the relative magnitude of the load voltage as a function of the phase change. For example, the load voltage is the voltage applied across the one or more LEDs 360. As an example, the load voltage corresponds to the load current 362 that flows through the one or more LEDs 360.

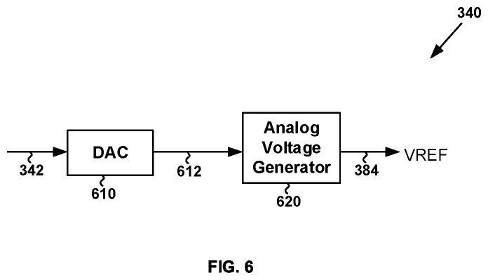

FIG. 6 is a simplified diagram of the voltage generator 340 of the lighting system 300 as shown in FIG. 3 according to some embodiments of the present invention. This diagram is merely an example, which should not unduly limit the scope of the claims. One of ordinary skill in the art would recognize many variations, alternatives, and modifications. The voltage generator 340 includes a digital-to-analog converter (DAC) 610 and an analog voltage generator 620. In some embodiments, the signal 342 is a digital signal that represents phase information of the voltage 382 (e.g., Vₛ), and the digital-to-analog converter (DAC) 610 receives the digital signal 342, converts the digital signal 342 to an analog signal 612 that also represents phase information of the voltage 382 (e.g., Vₛ), and outputs the analog signal 612 to the analog voltage generator 620. In certain examples, the analog voltage generator 620 receives the analog signal 612 and generates the reference voltage 384 (e.g., V_{REF}), which is an analog voltage. As an example, the reference voltage 384 (e.g., V_{REF}) is a DC voltage and is received by the driver 350. In some examples, the voltage generator 340 and the driver 350 use the curve 500 as shown in FIG. 5 to affect (e.g., to control) the load current 362 that flows through the one or more LEDs 360.

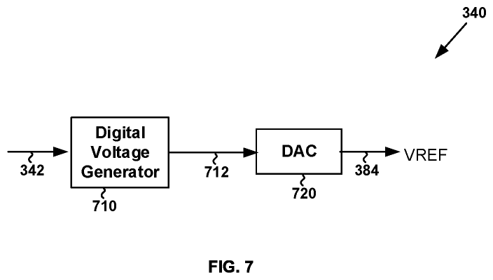

FIG. 7 is a simplified diagram of the voltage generator 340 of the lighting system 300 as shown in FIG. 3 according to certain embodiments of the present invention. This diagram is merely an example, which should not unduly limit the scope of the claims. One of ordinary skill in the art would recognize many variations, alternatives, and modifications. The voltage generator 340 includes a digital voltage generator 710 and a digital-to-analog converter (DAC) 720. In some embodiments, the signal 342 is a digital signal that represents phase information of the voltage 382 (e.g., Vₛ), and the digital voltage generator 710 receives the digital signal 342, generates a digital voltage 712 based at least in part on the digital signal 342, and outputs the digital voltage 712 to the digital-to-analog converter (DAC) 720. In certain examples, the digital-to-analog converter (DAC) 720 receives the digital voltage 712 and converts the digital voltage 712 to the reference voltage 384 (e.g., V_{REF}), which is an analog voltage. As an example, the reference voltage 384 (e.g., V_{REF}) is a DC voltage and is received by the driver 350. In some examples, the voltage generator 340 and the driver 350 use the curve 500 as shown in FIG. 5 to affect (e.g., to control) the load current 362 that flows through the one or more LEDs 360.

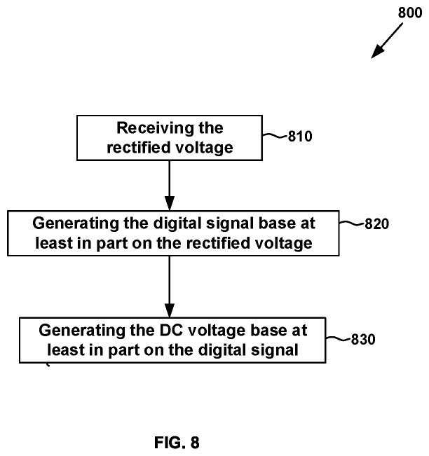

FIG. 8 is a simplified diagram of a method for generating the reference voltage 384 (e.g., V_{REF}) by the lighting system 300 as shown in FIG. 3 according to some embodiments of the present invention. This diagram is merely an example, which should not unduly limit the scope of the claims. One of ordinary skill in the art would recognize many variations, alternatives, and modifications. The method 800 includes a process 810 for receiving the rectified voltage 382, a process 820 for generating the digital signal 342 based at least in part on the rectified voltage 382, and a process 830 for generating the DC voltage 384 based at least in part on the digital signal 342, according to certain embodiments.

In certain embodiments, at the process 810, the rectified voltage 382 (e.g., Vₛ) is received by the phase detector 330. For example, the voltage divider including the resistors 370 and 372 receives the rectified output voltage 322 and, in response, generates the rectified voltage 382 (e.g., Vₛ) according to Equation 4.

In some embodiments, at the process 820, the phase detector 330 generates, based at least in part on the rectified voltage 382, the digital signal 342 that represents phase information of the rectified voltage 382 (e.g., Vₛ). For example, the digital signal 342 represents the phase change, within which, for each half cycle, the AC input voltage 314 (e.g., V_{Line}) is not clipped by the TRIAC dimmer 310. As an example, the digital signal 342 represents the total number of counts made within each half cycle of the AC input voltage 314 (e.g., each cycle of the voltage 382) when the AC input voltage 314 (e.g., V_{Line}) is not clipped by the TRIAC dimmer 310. For example, the digital signal 342 represents the time duration, during which, for each half cycle, the AC input voltage 314 (e.g., V_{Line}) is not clipped by the TRIAC dimmer 310.

In certain embodiments, at the process 830, the voltage generator 340 receives the digital signal 342 and generates the DC voltage 384 (e.g., V_{REF}) based at least in part on the digital signal 342. For example, the reference voltage 384 is received by the driver 350, which in response affects (e.g., controls) the load current 362 that flows through the one or more LEDs 360. As an example, the voltage generator 340 and the driver 350 use the curve 500 as shown in FIG. 5 to affect (e.g., to control), in response to the digital signal 342, the load current 362 that flows through the one or more LEDs 360.

According to some embodiments, the process 830 is performed by the voltage generator 340 as shown in FIG. 6. For example, the digital signal 342 is converted to the analog signal 612 that also represents phase information of the voltage 382 (e.g., Vₛ), and the analog signal 612 is used to generate the reference voltage 384 (e.g., V_{REF}), which is an analog voltage. As an example, the reference voltage 384 (e.g., V_{REF}) is used to affect (e.g., to control) the load current 362 that flows through the one or more LEDs 360 according to the curve 500 as shown in FIG. 5.

According to certain embodiments, the process 830 is performed by the voltage generator 340 as shown in FIG. 7. For example, the digital signal 342 is converted to the digital voltage 712, and the digital voltage 712 is used to generate the reference voltage 384 (e.g., V_{REF}), which is an analog voltage. As an example, the reference voltage 384 (e.g., V_{REF}) is used to affect (e.g., to control) the load current 362 that flows through the one or more LEDs 360 according to the curve 500 as shown in FIG. 5.

In some embodiments, the lighting system 300 does not use an RC filtering circuit that includes a resistor and a capacitor, and the lighting system 300 does not need a large capacitor to generate a DC voltage; therefore, the size and/or the cost of the IC chip is reduced. In certain embodiments, the curve 500 as shown in FIG. 5 is predetermined. In some examples, during the predetermination process, the curve 500 can be adjusted, so the one or more LEDs 360 can be driven in a flexible manner. As an example, different types of LEDs have different compatibilities with the TRIAC dimmer 310, so the curve 500 also depends on the types of LEDs. For example, the reaction of human eyes to brightness changes of the one or more LEDs 360 depends on the types of LEDs, so the curve 500 also depends on the types of LEDs. In certain examples, different predetermined curves 500 are used by the lighting system 300 without changing the circuit design, so the same circuit can be used to drives different types of the one or more LEDs 360. For example, the lighting system 300 can be adapted to different types of the one or more LEDs 360 by using different predetermined curves 500.

According to some embodiments, a system for voltage conversion to drive one or more light emitting diodes with at least a TRIAC dimmer, the system comprising: a phase detector configured to receive a first rectified voltage generated based at least in part on an AC input voltage processed by at least the TRIAC dimmer, the phase detector being further configured to generate a digital signal representing phase information associated with the first rectified voltage; a voltage generator configured to receive the digital signal and generate a DC voltage based at least in part on the digital signal; and a driver configured to receive the DC voltage and affect, based at least in part on the DC voltage, a current flowing through the one or more light emitting diodes; wherein the current changes with the phase information according to a predetermined function. For example, the system is implemented according to at least FIG. 3.

In some examples, the phase information includes a phase change, within which, for each cycle of the first rectified voltage, the AC input voltage is not clipped by the TRIAC dimmer. In certain examples, the phase information includes a time duration, within which, for each cycle of the first rectified voltage, the AC input voltage is not clipped by the TRIAC dimmer. In some examples, the phase information includes, for each cycle of the first rectified voltage, a total number of counts made by the phase detector when the AC input voltage is not clipped by the TRIAC dimmer.

In certain examples, the phase information includes a phase change, within which, for each cycle of the first rectified voltage, the AC input voltage is clipped by the TRIAC dimmer. In some examples, the phase information includes a time duration, within which, for each cycle of the first rectified voltage, the AC input voltage is clipped by the TRIAC dimmer. In certain examples, the phase information includes, for each cycle of the first rectified voltage, a total number of counts made by the phase detector when the AC input voltage is clipped by the TRIAC dimmer.

In some examples, the voltage generator includes a digital-to-analog converter and an analog voltage generator; wherein: the digital-to-analog converter is configured to receive the digital signal and convert the digital signal to an analog signal also representing the phase information associated with the first rectified voltage; and the analog voltage generator configured to receive the analog signal and generate the DC voltage based at least in part on the analog signal. In certain examples, the voltage generator includes a digital voltage generator and a digital-to-analog converter; wherein: the digital voltage generator is configured to receive the digital signal and generate a digital output voltage based at least in part on the digital signal; and the digital-to-analog converter is configured to receive the digital output voltage and convert the digital output voltage to the DC voltage.

In some examples, the system further includes: the TRIAC dimmer configured to receive the AC input voltage and generate a processed voltage by clipping at least a part of the AC input voltage; a rectifier configured to receive the processed voltage and generate a second rectified voltage; and a voltage divider configured to receive the second rectified voltage and generate the first rectified voltage.

According to some embodiments, a method for voltage conversion to drive one or more light emitting diodes with at least a TRIAC dimmer, the method comprising: receiving a first rectified voltage generated based at least in part on an AC input voltage processed by at least the TRIAC dimmer; processing at least information associated with the first rectified voltage; generating a digital signal representing phase information associated with the first rectified voltage; receiving the digital signal; generating a DC voltage based at least in part on the digital signal; receiving the DC voltage; and affecting, based at least in part on the DC voltage, a current flowing through the one or more light emitting diodes; wherein the current changes with the phase information according to a predetermined function. For example, the method is implemented according to at least FIG. 8.

In some examples, the phase information includes a phase change, within which, for each cycle of the first rectified voltage, the AC input voltage is not clipped by the TRIAC dimmer. In certain examples, the phase information includes a time duration, within which, for each cycle of the first rectified voltage, the AC input voltage is not clipped by the TRIAC dimmer. In some examples, the phase information includes, for each cycle of the first rectified voltage, a total number of counts made when the AC input voltage is not clipped by the TRIAC dimmer.

In certain examples, the phase information includes a phase change, within which, for each cycle of the first rectified voltage, the AC input voltage is clipped by the TRIAC dimmer. In some examples, the phase information includes a time duration, within which, for each cycle of the first rectified voltage, the AC input voltage is clipped by the TRIAC dimmer. In certain examples, the phase information includes, for each cycle of the first rectified voltage, a total number of counts made when the AC input voltage is clipped by the TRIAC dimmer.

In some examples, the generating a DC voltage based at least in part on the digital signal includes: receiving the digital signal; converting the digital signal to an analog signal also representing the phase information associated with the first rectified voltage; receiving the analog signal; and generating the DC voltage based at least in part on the analog signal. In certain examples, the generating a DC voltage based at least in part on the digital signal includes: receiving the digital signal; generating a digital output voltage based at least in part on the digital signal; receiving the digital output voltage; and converting the digital output voltage to the DC voltage.

In some examples, the method further includes: receiving the AC input voltage; generating a processed voltage by clipping at least a part of the AC input voltage; receiving the processed voltage; processing at least information associated with the processed voltage; generating a second rectified voltage based at least in part on the processed voltage; receiving the second rectified voltage; and generating the first rectified voltage based at least in part on the second rectified voltage.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Although specific embodiments of the present invention have been described, it will be understood by those of skill in the art that there are other embodiments that are equivalent to the described embodiments. Accordingly, it is to be understood that the invention is not to be limited by the specific illustrated embodiments.

1.-20. (canceled)

21. A system for voltage conversion to drive one or more light emitting diodes with at least a TRIAC dimmer, the system comprising:
a phase detector configured to receive a first rectified voltage generated based at least in part on an AC input voltage processed by at least the TRIAC dimmer, the phase detector being further configured to generate a digital signal representing phase information associated with the first rectified voltage;
a signal generator configured to receive the digital signal and generate a voltage signal, the signal generator further configured to affect, based at least in part on the voltage signal, a current flowing through the one or more light emitting diodes;
wherein:
the phase information includes a phase change;
a relative magnitude of the current is represented in percentage, the relative magnitude being one hundred percent when each of the one or more light emitting diodes is turned on and at a maximum brightness;
if the phase change is less than a first degree, a relative magnitude of the current is equal to zero percent;
if the phase change is greater than the first degree and smaller than a second degree, the relative magnitude of the current increases linearly with the phase change at a first slope from zero percent to a first percent, the second degree being greater than the first degree, the first percent being greater than zero percent;
if the phase change is greater than the second degree and smaller than a third degree, the relative magnitude of the current increases linearly with the phase change at a second slope from the first percent to a second percent, the third degree being greater than the second degree, the second percent being greater than the first percent;
if the phase change is greater than the third degree and smaller than a fourth degree, the relative magnitude of the current changes is equal to the second percent, the fourth degree being greater than the third degree; and
the first slope is different from the second slope.

22. The system of claim 21 wherein the phase information includes a phase change, within which, for each cycle of the first rectified voltage, the AC input voltage is not clipped by the TRIAC dimmer.

23. The system of claim 21 wherein the phase information includes a time duration, within which, for each cycle of the first rectified voltage, the AC input voltage is not clipped by the TRIAC dimmer.

24. The system of claim 21 wherein the phase information includes, for each cycle of the first rectified voltage, a total number of counts made by the phase detector when the AC input voltage is not clipped by the TRIAC dimmer.

25. The system of claim 21 wherein the phase information includes a phase change, within which, for each cycle of the first rectified voltage, the AC input voltage is clipped by the TRIAC dimmer.

26. The system of claim 21 wherein the phase information includes a time duration, within which, for each cycle of the first rectified voltage, the AC input voltage is clipped by the TRIAC dimmer.

27. The system of claim 21 wherein the phase information includes, for each cycle of the first rectified voltage, a total number of counts made by the phase detector when the AC input voltage is clipped by the TRIAC dimmer.

28. The system of claim 21 wherein:
the signal generator includes a digital-to-analog converter and an analog voltage generator;
wherein:
the digital-to-analog converter is configured to receive the digital signal and convert the digital signal to an analog signal also representing the phase information associated with the first rectified voltage; and
the analog voltage generator configured to receive the analog signal and generate the voltage signal based at least in part on the analog signal.

29. The system of claim 21 wherein:
the signal generator includes a digital voltage generator and a digital-to-analog converter;
wherein:
the digital voltage generator is configured to receive the digital signal and generate a digital output voltage based at least in part on the digital signal; and
the digital-to-analog converter is configured to receive the digital output voltage and convert the digital output voltage to the voltage signal.

30. The system of claim 21 wherein the TRIAC dimmer is configured to receive the AC input voltage and generate a processed voltage by clipping at least a part of the AC input voltage;
the system further comprising:
a rectifier configured to receive the processed voltage and generate a second rectified voltage; and
a voltage divider configured to receive the second rectified voltage and generate the first rectified voltage.

31. A method for voltage conversion to drive one or more light emitting diodes with at least a TRIAC dimmer, the method comprising:
receiving a first rectified voltage generated based at least in part on an AC input voltage processed by at least the TRIAC dimmer;
processing at least information associated with the first rectified voltage;
generating a digital signal representing phase information associated with the first rectified voltage;
receiving the digital signal;
generating a voltage signal based at least in part on the digital signal; and
affecting, based at least in part on the voltage signal, a current flowing through the one or more light emitting diodes;
wherein:
the phase information includes a phase change;
a relative magnitude of the current is represented in percentage, the relative magnitude being one hundred percent when each of the one or more light emitting diodes is turned on and at a maximum brightness;
if the phase change is less than a first degree, the relative magnitude of the current is equal to zero percent;
if the phase change is greater than the first degree and smaller than a second degree, the relative magnitude of the current increases linearly with the phase change at a first slope from zero percent to a first percent, the second degree being greater than the first degree, the first percent being greater than zero percent;
if the phase change is greater than the second degree and smaller than a third degree, the relative magnitude of the current increases linearly with the phase change at a second slope from the first percent to a second percent, the third degree being greater than the second degree, the second percent being greater than the first percent;
if the phase change is greater than the third degree and smaller than a fourth degree, the relative magnitude of the current changes is equal to the second percent, the fourth degree being greater than the third degree; and
the first slope is different from the second slope.

32. The method of claim 31 wherein the phase information includes a phase change, within which, for each cycle of the first rectified voltage, the AC input voltage is not clipped by the TRIAC dimmer.

33. The method of claim 31 wherein the phase information includes a time duration, within which, for each cycle of the first rectified voltage, the AC input voltage is not clipped by the TRIAC dimmer.

34. The method of claim 31 wherein the phase information includes, for each cycle of the first rectified voltage, a total number of counts made when the AC input voltage is not clipped by the TRIAC dimmer.

35. The method of claim 31 wherein the phase information includes a phase change, within which, for each cycle of the first rectified voltage, the AC input voltage is clipped by the TRIAC dimmer.

36. The method of claim 31 wherein the phase information includes a time duration, within which, for each cycle of the first rectified voltage, the AC input voltage is clipped by the TRIAC dimmer.

37. The method of claim 31 wherein the phase information includes, for each cycle of the first rectified voltage, a total number of counts made when the AC input voltage is clipped by the TRIAC dimmer.

38. The method of claim 31 wherein the generating a voltage signal based at least in part on the digital signal includes:
converting the digital signal to an analog signal representing the phase information associated with the first rectified voltage;
receiving the analog signal; and
generating the voltage signal based at least in part on the analog signal.

39. The method of claim 31 wherein the generating a voltage signal based at least in part on the digital signal includes:
generating a digital output voltage based at least in part on the digital signal;
receiving the digital output voltage; and
converting the digital output voltage to the voltage signal.

40. The method of claim 31, and further comprising:
receiving the AC input voltage;
generating a processed voltage by clipping at least a part of the AC input voltage;
receiving the processed voltage;
processing at least information associated with the processed voltage;
generating a second rectified voltage based at least in part on the processed voltage;
receiving the second rectified voltage; and
generating the first rectified voltage based at least in part on the second rectified voltage.
